(19) United States
(12) Patent Application Publication
(10) Pub. No.: US 2006/0276922 A1
(43) Pub. Date: Dec. 7, 2006

(54) Systems and methods of process control

(75) Inventors: Chia-Cheng Hsu, Taoyuan County (TW); Chien-Chung Chen, Hsinchu City (TW); Ming-Chang Lin, Hsinchu County (TW); Shih-Tsung Hsiao, Hsinchu City (TW)

Correspondence Address: BIRCH STEWART KOLASCH & BIRCH, PO BOX 747, FALLS CHURCH, VA, 22040-0747, US

(73) Assignee: Powerchip Semiconductor Corp.

(21) Appl. No.: 11/402,804

(22) Filed: Apr. 13, 2006

(30) Foreign Application Priority Data
Jun. 2, 2005 (TW) 94118162

(51) Int. Cl. G06F 19/00

(52) U.S. Cl. 700/110

(57) ABSTRACT

A system of process control. A measurement database stores work-in-process (WIP) measurement data. A monitor database stores tool monitor data. A design of experiment (DOE) database stores DOE data determined by a method of design of experiment, comprising tool operation data and WIP measurement data. A processor determines a compensation value according to preset process target data and the WIP measurement data, and determines tool adjustment data according to the compensation value, the tool monitor data, and the formula pertaining to processing factors.

### BACKGROUND

The present invention relates to manufacturing control in a semiconductor manufacturing environment, and particularly to systems and methods of processing tool control.

This section is intended to introduce the reader to various aspects of art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

A continued emphasis on semiconductor device miniaturization, leading to the technological evolution of Large Scale Integration (LSI), Very Large Scale Integration (VLSI) and Ultra Large Scale Integration (ULSI), which has resulted in shorter inter-linear device distances. As a result of increased semiconductor device density, optimization of processing tool is required to obtain precise line width.

Referring to FIG. 1, a conventional control mechanism for a processing tool in a manufacturing environment is illustrated. According to conventional IC (integrated circuit) manufacturing, IC work-in-process (WIP) is inspected at a first metrology tool 131 before processing at processing tool 11, and pre-process measurement data is obtained accordingly. The pre-process measurement data is then transmitted to controller 15, and a feed forward controlling process 100 is implemented accordingly to adjust parameter setting of the processing tool 11. The IC WIP is inspected at a second metrology tool 135 after it is processed by the processing tool 11, and post-process measurement data is obtained accordingly. The post-process measurement data is then transmitted to controller 15, and a feed backward controlling process 150 is implemented accordingly to adjust parameter settings of the processing tool 11.

The processing tool 11 may shift during operation. Adjustment based simply on the difference between the pre-process measurement data and post-process measurement data can not rectify manufacturing errors that occur due to the shifting of the processing tool.

The conventional method fails to rectify the shifting of the processing tool. Yield of IC product, therefore, drops due to unreliable settings for processing tool.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

A method of adjusting a processing tool is provided. Process target data, work-in-process (WIP) measurement data, and tool monitor data are provided. Design of experiment (DOE) data is also provided, and a formula pertaining to processing factors is determined accordingly. A compensation value is determined according to the process target data and the WIP measurement data. Tool adjustment data is determined according to the compensation value, the tool monitor data, and the formula pertaining to processing factors.

Also provided is a system of process control. The system comprises a measurement database, a monitor database, a design of experiment (DOE) database, and a processor. The measurement database stores work-in-process (WIP) measurement data. The monitor database stores tool monitor data. The design of experiment (DOE) database stores DOE data determined by a method of design of experiment, comprising tool operation data and WIP measurement data. The processor determines a compensation value according to preset process target data and the WIP measurement data, and determines tool adjustment data according to the compensation value, the tool monitor data, and the formula pertaining to processing factors.

Also provided is a fabrication system. The fabrication system comprises a processing tool, a monitor, and a controller. The processing tool processes semiconductor work-in-process (WIP). The monitor monitors the processing tool to obtain operation data of the processing tool. The controller determines a compensation value according to preset process target data and measurement data of the semiconductor WIP, and determines tool adjustment data according to the compensation value, the tool monitor data, and a preset formula pertaining to processing factors, whereby controlling the processing tool.

### BRIEF DESCRIPTION OF DRAWINGS

The present invention can be more fully understood by reading the subsequent detailed description and examples with references made to the accompanying drawings, wherein:

FIG. 1 illustrates a conventional control mechanism for a processing tool in a manufacturing environment;

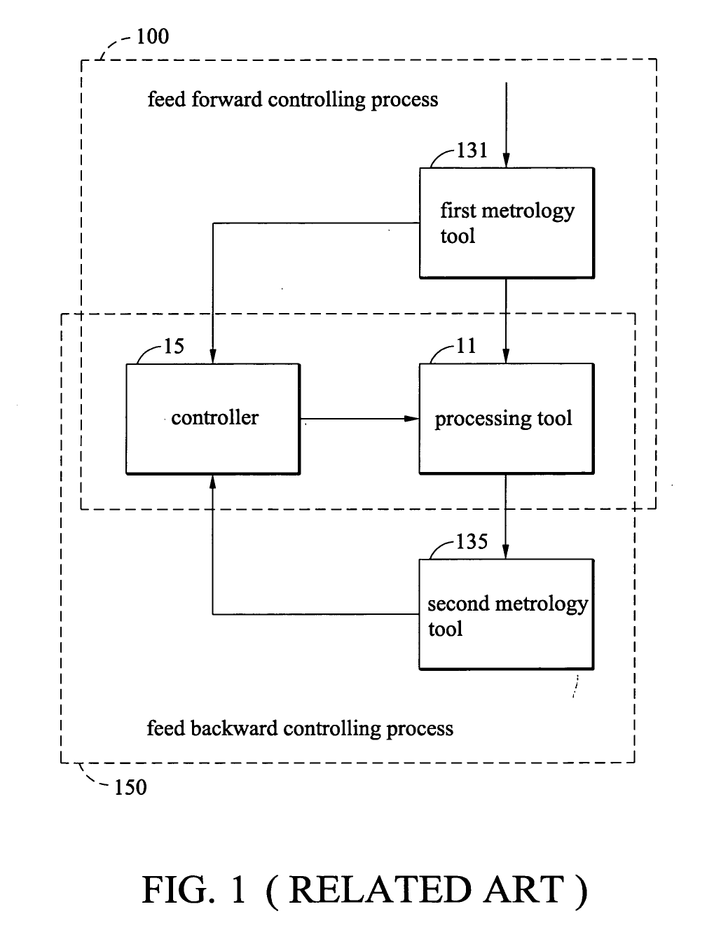

FIG. 2 is a schematic view of a fabrication system according to the invention;

FIG. 3 illustrates a flowchart of an embodiment of a method of process control; and

FIG. 4 illustrates a wafer processed by an embodiment of the processing method.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort may be complex and time consuming, but would nevertheless be a routine undertaking of design, fabrication, and manufacture for those of ordinary skill having the benefit of this disclosure.

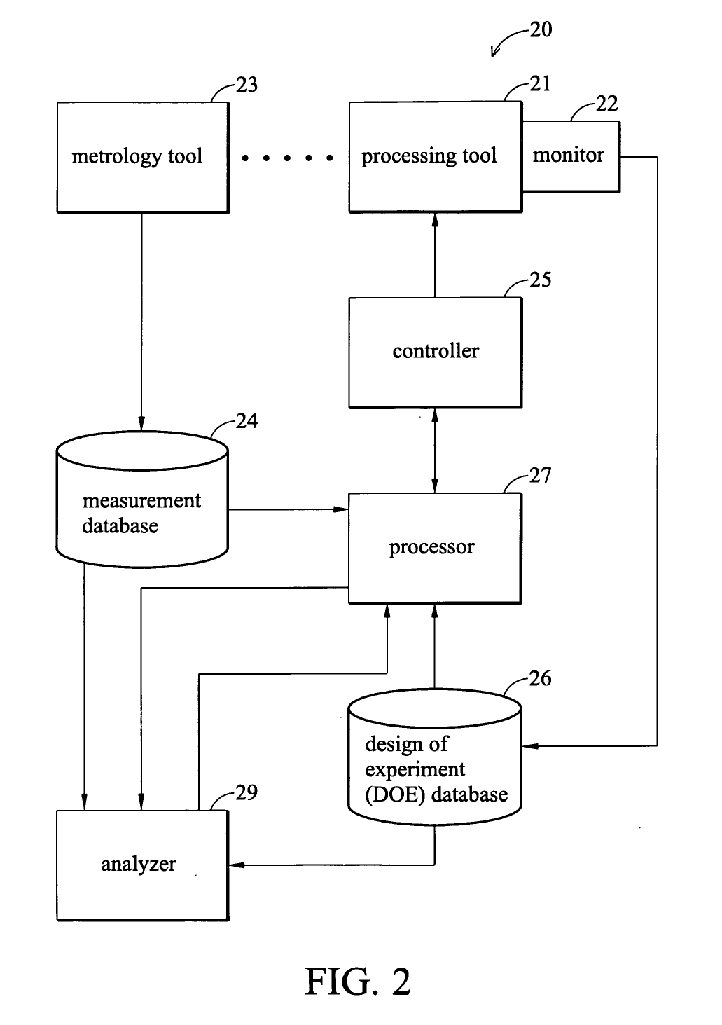

The invention will now be described with reference to FIGS. 2 through 4, which generally relate to a fabrication system. In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

FIG. 2 is a schematic view of a fabrication system according to embodiments of the invention. Fabrication system 20 is a semiconductor fabrication system, comprising a processing tool 21, a monitor 22, a metrology tool 23, a controller 25, a measurement database 24, a design of experiment (DOE) database 26, a processor 27, and an analyzer 29.

The processing tool 21 processes IC work-in-process (WIP). The processing tool 21 may be any tool that performs a processing step during manufacturing processes of a semiconductor device. The monitor 22 monitors the processing tool 21 to obtain operation data of the processing tool 21 during operation, such as temperature, and PH value.

The metrology tool 23 performs inspection on the IC WIP before and after the IC WIP is processed by the processing tool 21, obtaining pre-process measurement data and post-process measurement data pertaining to the IC WIP. The measurement database 24 stores the pre-process measurement data and post-process measurement data obtained by the metrology tool 23, such as film thickness data.

The design of experiment (DOE) database 26 stores DOE data determined by a method of design of experiment, comprising tool operation data and WIP measurement data. For example, tool parameters determined by a DOE method, such as, optimized parameter settings obtained from the relationship between the concentration of acid, temperature, and etching rate. The described etching rate is a function of the concentration of acid, temperature, and processing time. For example, E=F(A, B, C), wherein E corresponds to etching rate, A corresponds to concentration of acid, B corresponds to temperature, and C corresponds to processing time.

The controller 25 determines process target data for the WIP processed by the processing tool 21, and parameter setting for the processing tool 21. The controller 25 controls operation of the processing tool 21 according to the parameter setting.

The processor 27 performs feed forward and feed backward control on the processing tool 21 through controller 25. The processor 27 obtains data pertaining to the processed WIP and the pre-process measurement data and post-process measurement data from measurement database 24. The processor 27 determines a WIP measurement variation value, changed amount of the WIP measurement before and after the process, according to the pre-process measurement data and post-process measurement data, and compares the WIP measurement variation value with the process target data. The processor 27 determines a compensation value according to the process target data and the WIP measurement data.

The processor 27 further determines a formula pertaining to processing factors according to the design of experiment (DOE) data, wherein the formula pertaining to processing factors specifies the algorithmic relationship of the WIP measurement data and the tool monitor data. The processor 27 further substitutes the compensation value into the formula pertaining to processing factors, and determines tool adjustment data for adjusting the processing tool accordingly.

Fabrication system 20 also comprises analyzer 29 to verify that the formula pertaining to processing factors correctly specifies the algorithmic relationship of the WIP measurement data and the tool monitor data. The analyzer 29 retrieves tool monitor data, work-in-process (WIP) measurement data, design of experiment (DOE) data, and the compensation value from the monitor 22, measurement database 24, design of experiment (DOE) database 26, and processor 27, respectively. The analyzer 29 performs a regression analysis according to the tool monitor data, the WIP measurement data, the DOE data, and the compensation value, and determines whether the algorithmic relationship between the tool monitor data and the WIP measurement data conforms to a result of the regression analysis. When the algorithmic relationship between the tool monitor data and the WIP measurement data conforms to a result of the regression analysis, the formula pertaining to processing factors is amended accordingly. The amended formula is sent to processor 27, and is used for tool adjustment.

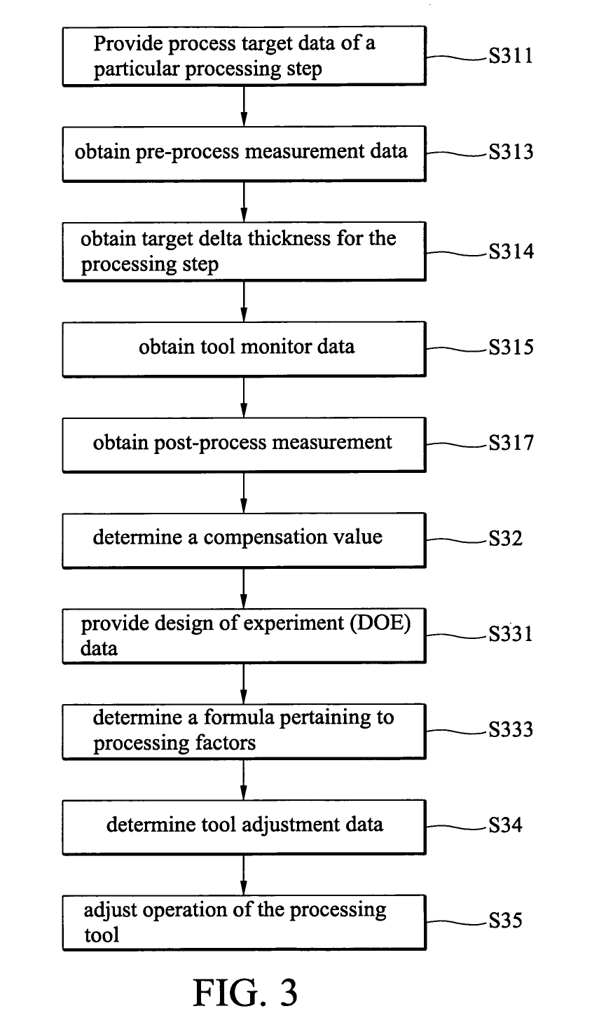

FIG. 3 illustrates a flowchart of an embodiment of a method of process control. The method illustrated in FIG. 3 can be implemented in the system of FIG. 2. The method illustrated in FIG. 3 may be used for adjusting parameters directing operation of processing tool 21. The processing tool 21 may be any tool that performs a processing step during manufacturing processes of a semiconductor device.

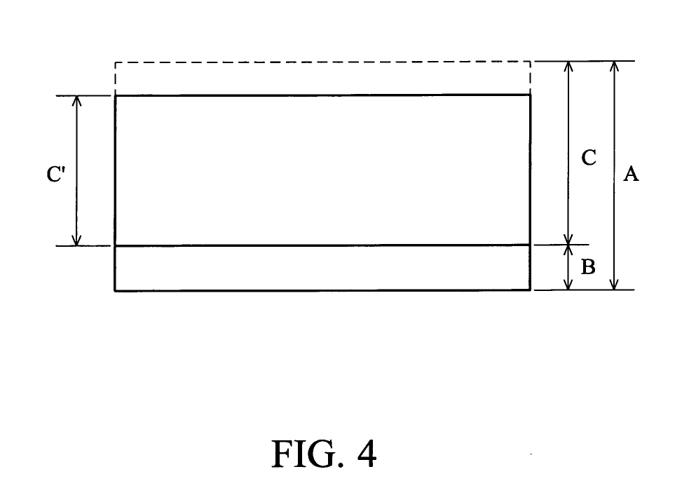

Process target data of a particular processing step is provided (step S311). A measuring step is performed on a wafer before the wafer is processed by a processing tool, whereby pre-process measurement data is obtained (step S313). Referring to FIG. 4, the processing tool generates a film with thickness “A” on the wafer. Additionally, according to the pre-process measurement, thickness of the film is “B” before the processing step. The target delta thickness for the processing step is the difference between the original film thickness and the target film thickness, C=(A−B) (step S314). When the processing tool performs the processing step, operation of the processing tool is monitored in real time by a monitor, whereby obtaining tool monitor data (step S315).

Another measuring step is performed on the wafer after the wafer is processed by a processing tool, whereby post-process measurement is obtained (step S317). Here, the actual film thickness after the processing step is D, and the post-process measurement is C′=(D−B).

A compensation value is then determined according to the process target data and the pre-process and post-process measurement data (step S32). Here, the compensation value is a difference between the target film thickness (C) and the actual film thickness (C′) representing the difference between a process target and an actual process result.

In step S331, design of experiment (DOE) data is provided, comprising operation data pertaining to the-processing tool. A formula pertaining to processing factors is determined according to the DOE data (step S333), wherein the formula pertaining to processing factors specifies the algorithmic relationship of the WIP measurement data and the tool monitor data. For example, the formula pertaining to processing factors specifies the relationship between the film thickness and factors such as processing temperature, pressure, and other relating factors.

In step S34, tool adjustment data is determined according to the compensation value, the tool monitor data, and the formula pertaining to processing factors. Here, the compensation value is a difference between the target film thickness (C) and the actual film thickness (C′), representing the difference between a process target and an actual process result. For example, in step S34, settings pertaining to processing temperature and pressure of the processing tool can be adjusted according to the relationship between the film thickness and the processing temperature and pressure specified by the formula.

In step S35, the operation of the processing tool is adjusted according to the data for adjusting the processing tool, whereby the WIP processed by the processing tool conforms to the process target data.

The described method further performs a regression analysis according to the tool monitor data, the WIP measurement data, the DOE data, and the compensation value, and it is determined whether the algorithmic relationship between the tool monitor data and the WIP measurement data conforms to a result of the regression analysis. When the algorithmic relationship between the tool monitor data and the WIP measurement data conforms to a result of the regression analysis, the formula pertaining to processing factors is further amended accordingly.

The described step of regression analysis can be performed according to a preset schedule, or can be performed according to user instruction, whereby the formula is verified.

The described method implements a feed forward mechanism targeting a particular WIP lot. According to the feed forward mechanism, a pre-process measurement is first obtained (for example, original film thickness), a feed forward control target (target 2) is then determined by subtracting the original film thickness from a preset target film thickness (target 1), whereby a required delta thickness in a particular processing step is determined. According to an embodiment, the feed forward mechanism can be implemented with the DOE data to determine the tool adjustment data directing operation of the processing tool. For example, the tool monitor data are transmitted from the monitor to the processor 27. The processor 27 determines a film growth rate according to the tool monitor data and the formula pertaining to processing factors. The estimated film growth rate and the required delta thickness in a particular processing step may be used to determine the processing time required for the processing step. A date specifying the processing time is then transmitted from the processor 27 to the controller 25.

Additionally, according to another embodiment, a feed backward mechanism may be implemented. For example, the post-process film thickness of a first lot of wafers is measured, and the original film thickness is subtracted from the post-process film thickness, whereby actual increased film thickness is obtained. The actual increased film thickness is then compared with the required delta thickness in the particular processing step (feed forward control target data), and a difference (a compensation value) therebetween is determined. Parameter settings directing the operation of the processing tool are then determined by processor 27 according to the compensation value and the DOE data, and transmitted to control 25.

While the invention has been described by way of example and in terms of the preferred embodiments, it is to be understood that the invention is not limited to the disclosed embodiments. To the contrary; it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of adjusting a processing tool, comprising:
providing process target data, work-in-process (WIP) measurement data, and tool monitor data;
providing design of experiment (DOE) data, and determining a formula pertaining to processing factors accordingly;
determining a compensation value according to the process target data and the WIP measurement data; and
determining tool adjustment data according to the compensation value, the tool monitor data, and the formula pertaining to processing factors.

2. The method of claim 1, wherein the WIP measurement data comprises pre-process measurement data and post-process measurement data.

3. The method of claim 2, further comprising determining a WIP measurement variation value, which is changing amount of the WIP measurement data before and after the process, by using the pre-process measurement data and post-process measurement data, and comparing the WIP measurement variation value with the process target data.

4. The method of claim 1, wherein the formula pertaining to processing factors specifies the algorithmic relationship of the WIP measurement data and the tool monitor data.

5. The method of claim 1, wherein the compensation value is a difference between the process target data and the WIP measurement data.

6. The method of claim 1, further comprising substituting the compensation value into the formula pertaining to processing factors, and determining the tool adjustment data for adjusting the processing tool accordingly.

7. The method of claim 1, further comprising an adjusting operation of the processing tool according to the data for adjusting the processing tool, whereby the WIP processed by the processing tool conforms to the process target data.

8. The method of claim 1, further comprising performing regression analysis according to the tool monitor data, the WIP measurement data, the DOE data, and the compensation value, and determining whether the algorithmic relationship between the tool monitor data and the WIP measurement data conforms to a result of the regression analysis.

9. The method of claim 8, when the algorithmic relationship between the tool monitor data and the WIP measurement data does not conform to a result of the regression analysis, further comprising amending the formula pertaining to processing factors accordingly.

10. A system of process control, comprising:
a measurement database storing work-in-process (WIP) measurement data;
a monitor database storing tool monitor data;
a design of experiment (DOE) database storing DOE data determined by a method of design of experiment, comprising tool operation data and WIP measurement data; and
a processor determining a compensation value according to preset process target data and the WIP measurement data, and determining tool adjustment data according to the compensation value, the tool monitor data, and the formula pertaining to processing factors.

11. The system of claim 10, wherein the WIP measurement data comprises pre-process measurement data and post-process measurement data.

12. The system of claim 11, wherein the processor further determines a WIP measurement variation value, which is changed amount of the WIP measurement before and after the process, according to the pre-process measurement data and post-process measurement data, and comparing the WIP measurement variation value with the process target data.

13. The system of claim 10, wherein the formula pertaining to processing factors specifies the algorithmic relationship of the WIP measurement data and the tool monitor data.

14. The system of claim 10, wherein the compensation value is a difference between the process target data and the WIP measurement data.

15. The system of claim 10, wherein the processor further substitutes the compensation value into the formula pertaining to processing factors, and determines data for adjusting the processing tool accordingly.

16. The system of claim 10, wherein the processor further adjusts operation of the processing tool according to the data for adjusting the processing tool, whereby the WIP processed by the processing tool conforms to the process target data.

17. The system of claim 10, further comprising an analyzer performing regression analysis according to the tool monitor data, the WIP measurement data, the DOE data, and the compensation value, and determining whether the algorithmic relationship between the tool monitor data and the WIP measurement data conforms to a result of the regression analysis.

18. The system of claim 17, wherein, when the algorithmic relationship between the tool monitor data and the WIP measurement data does not conform to a result of the regression analysis, the processor further amends the formula pertaining to processing factors accordingly.

19. A fabrication system, comprising:
a processing tool processing semiconductor work-in-process (WIP);
a monitor monitoring the processing tool to obtain operation data of the processing tool; and
a controller determining a compensation value according to preset process target data and measurement data of the semiconductor WIP, and determining tool adjustment data according to the compensation value, the tool monitor data, and a preset formula pertaining to processing factors, whereby controlling the processing tool.

20. The system of claim 19, further comprising a metrology tool performing a measuring step to obtain the measurement data of the semiconductor WIP.

21. The system of claim 19, further comprising a design of experiment (DOE) database storing the formula pertaining to processing factors, which is predetermined by a method of design of experiment.

22. The system of claim 19, wherein the WIP measurement data comprises pre-process measurement data and post-process measurement data.

23. The system of claim 19, wherein the controller further determines a WIP measurement variation value, which is changed amount of the WIP measurement before and after the process, according to the pre-process measurement data and post-process measurement data.

24. The system of claim 19, wherein the formula pertaining to processing factors specifies the algorithmic relationship of the WIP measurement data and the tool monitor data.

25. The system of claim 19, wherein the compensation value is a difference between the process target data and the WIP measurement data.

26. The system of claim 19, wherein the controller further substitutes the compensation value into the formula pertaining to processing factors, and determines data for adjusting the processing tool accordingly.

27. The system of claim 19, wherein the controller further adjusts operation of the processing tool according to the data for adjusting the processing tool, whereby the WIP processed by the processing tool conforms to the process target data.

28. The system of claim 19, further comprising an analyzer performing regression analysis according to the tool monitor data, the WIP measurement data, the DOE data, and the compensation value, and determining whether the algorithmic relationship between the tool monitor data and the WIP measurement data conforms to a result of the regression analysis.

29. The system of claim 28, wherein, when the algorithmic relationship between the tool monitor data and the WIP measurement data does not conform to a result of the regression analysis, the processor further amends the formula pertaining to processing factors accordingly.
